(19) United States
(12) Patent Application Publication
(10) Pub. No.: US 2025/0375787 A1
(43) Pub. Date: Dec. 11, 2025

(54) Protective Cover System for Garden Sprinkers

(71) Applicant: Vardan Mamikonyan, Glendale, CA (US)

(72) Inventor: Vardan Mamikonyan, Glendale, CA (US)

(21) Appl. No.: 18/735,038

(22) Filed: Jun. 5, 2024

(51) Int. Cl. B05B 15/16

(52) U.S. Cl. CPC B05B 15/16

(57) ABSTRACT

A device with a protective cover system designed to enhance the durability and longevity of garden sprinklers. The device comprises a PVC material that encases the sprinkler and features a lid mechanism that dynamically opens and closes in sync with the movement of the sprinkler. This innovative design prevents damage caused by external elements such as dirt and debris during the sprinkler's operation. The invention aims to safeguard and maintain the optimal functionality of garden sprinklers, ultimately contributing to improved irrigation efficiency and reduced maintenance costs.

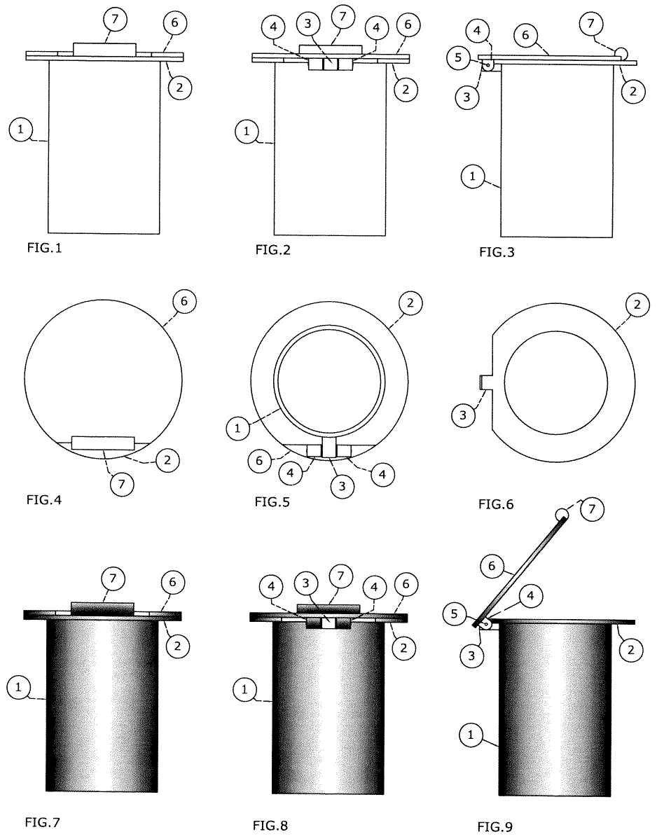

### BACKGROUND

Garden sprinklers are vital in maintaining lush and healthy landscapes by efficiently distributing water. However, these essential devices are susceptible to damage from environmental factors such as dirt, debris, and the surrounding grass. Over time, repeated exposure to these elements can lead to malfunctions and decreased performance, necessitating costly repairs or replacements. The need for a reliable protective solution to mitigate these issues has driven the development of the automated protective cover system described herein.

### SUMMARY

The automated protective cover system for garden sprinklers represents a groundbreaking advancement in irrigation technology, addressing environmental damage to essential garden infrastructure. While invaluable for maintaining vibrant landscapes, traditional garden sprinklers are frequently subjected to degradation caused by external elements such as dirt, debris, and its surrounding grass. This deterioration not only compromises the efficiency of the sprinkler but also incurs significant maintenance costs for property owners and landscapers.

The system integrates a PVC enclosure with a lid mechanism. This enclosure snugly fits around the garden sprinkler, forming a protective barrier that shields it from potential harm. The lid, a pivotal component of the invention, operates in harmony with the vertical movement of the sprinkler. As the sprinkler rises to commence its watering routine, the lid dynamically opens to expose the sprinkler head, allowing for unimpeded water distribution across the garden.

Upon completion of its watering cycle, the sprinkler gradually lowers back into its resting position, and concurrently, the lid descends to encapsulate and secure the entire sprinkler assembly. This automated process ensures that the sprinkler is safeguarded from detrimental elements during inactivity, mitigating the risk of damage caused by accumulated dirt, debris, or adverse weather conditions.

The system detects the status of the sprinkler, enabling the lid mechanism to respond in real time. The result is a self-contained and adaptive solution that minimizes the need for manual intervention while maximizing the protective benefits provided by the garden sprinkler.

In addition to its protective function, the automated cover system boasts a user-friendly design, allowing for easy installation and compatibility with various garden sprinkler models. Its durability, resistance to environmental factors, and low maintenance requirements make it a cost-effective investment for property owners seeking to prolong the lifespan and performance of their irrigation systems.

The automated protective cover system for garden sprinklers is a pioneering invention poised to revolutionize the landscaping and irrigation industry. By mitigating the impact of external elements on garden sprinklers, this system not only preserves the integrity of essential infrastructure but also reduces maintenance costs, positioning itself as a valuable asset for property owners and landscapers alike.

### LABELING FOR PROTECTIVE COVER SYSTEM FOR GARDEN SPRINKLERS DETAILED DESCRIPTION OF DRAWINGS (SEE REFERENCE ON PAGE 10)

### Drawing: Cross-sectional View of the Protective Cover System

1. Cylinder: This component delineates the outermost boundary of the cylindrical structure, comprising durable materials such as PVC, providing structural protection.
2. Upper Part of Cylinder: The extended border serves as an additional protective layer, safeguarding the inner mechanisms of the sprinkler system against external elements such as debris, harsh weather conditions, and accidental damage.
3. Lid Stopper: This feature acts as a stopper for the lid, ensuring that the lid stays open at a certain angle during sprinkler activation.
4. Hinge: The hinge facilitates the pivotal movement of the lid, enabling easy access to the sprinkler mechanism while maintaining a connected and controlled opening and closing motion.
5. Hole in the Hinge With Pin: This perforation accommodates the insertion of a pin, which serves as a pivot point for the hinge, enabling smooth rotational movement of the lid without detachment from the main structure.
6. Lid: The lid covers the cylindrical structure, offering additional protection against environmental factors such as rain, snow, and UV radiation, ensuring the longevity and functionality of the garden sprinkler system.
7. Mini Cylinder of the Lid: This cylindrical segment constitutes the main body of the lid, seamlessly integrating with the protective cover system while providing ample space for the internal components of the sprinkler mechanism.

### BRIEF DESCRIPTION OF DRAWINGS (SEE REFERENCE ON PAGE 10)

FIG. A: Front View
1. Cylinder: The outer perimeter of the cylindrical structure, delineating its boundary and providing structural support.
2. Upper Part of Cylinder: An extended border surrounding the cylindrical structure, enhancing protective coverage and stability.
6. Lid: A protective covering for the cylindrical structure, shielding the internal components from environmental factors.
7. Mini Cylinder of the Lid: The main body of the lid, seamlessly integrating with the protective cover system.

FIG. B: Rear View
1. Cylinder: The outer perimeter of the cylindrical structure, delineating its boundary and providing structural support.
2. Upper Part of Cylinder: An extended border surrounding the cylindrical structure, enhancing protective coverage and stability.
3. Lid Stopper: A component designed to secure the lid in place when opened.
4. Hinge: A mechanism facilitating the rotational movement of the lid for easy access to the sprinkler mechanism.
6. Lid: A protective covering for the cylindrical structure, shielding the internal components from environmental factors.
7. Mini Cylinder of the Lid: The main body of the lid, seamlessly integrating with the protective cover system.

FIG. C: Side View
1. Cylinder: The outer perimeter of the cylindrical structure, delineating its boundary and providing structural support.
2. Upper Part of Cylinder: An extended border surrounding the cylindrical structure, enhancing protective coverage and stability.
3. Lid Stopper: A component designed to secure the lid in place when opened.
4. Hinge: A mechanism facilitating the rotational movement of the lid for easy access to the sprinkler mechanism.
5. Hole in the Hinge With Pin: A perforation in the hinge allowing the insertion of a pin, enabling smooth pivoting of the lid.
6. Lid: A protective covering for the cylindrical structure, shielding the internal components from environmental factors.
7. Mini Cylinder of the Lid: The main body of the lid, seamlessly integrating with the protective cover system.

FIG. D: Top View With Lid
2. Upper Part of Cylinder: An extended border surrounding the cylindrical structure, enhancing protective coverage and stability.
6. Lid: A protective covering for the cylindrical structure, shielding the internal components from environmental factors.
7. Mini Cylinder of the Lid: The main body of the lid, seamlessly integrating with the protective cover system.

FIG. E: Bottom View
1. Cylinder: The outer perimeter of the cylindrical structure, delineating its boundary and providing structural support.
2. Upper Part of Cylinder: An extended border surrounding the cylindrical structure, enhancing protective coverage and stability.
3. Lid Stopper: A component designed to secure the lid in place when opened.
4. Hinge: A mechanism facilitating the rotational movement of the lid for easy access to the sprinkler mechanism.
6. Lid: A protective covering for the cylindrical structure, shielding the internal components from environmental factors.

FIG. F: Top View Without Lid
2. Upper Part of Cylinder: An extended border surrounding the cylindrical structure, enhancing protective coverage and stability.
3. Lid Stopper: A component designed to secure the lid in place when opened.

FIG. G: Front View (Perspective shadowing)
1. Cylinder: The outer perimeter of the cylindrical structure, delineating its boundary and providing structural support.
2. Upper Part of Cylinder: An extended border surrounding the cylindrical structure, enhancing protective coverage and stability.
6. Lid: A protective covering for the cylindrical structure, shielding the internal components from environmental factors.
7. Mini Cylinder of the Lid: The main body of the lid, seamlessly integrating with the protective cover system.

FIG. H: Rear View (Perspective shadowing)
1. Cylinder: The outer perimeter of the cylindrical structure, delineating its boundary and providing structural support.
2. Upper Part of Cylinder: An extended border surrounding the cylindrical structure, enhancing protective coverage and stability.
3. Lid Stopper: A component designed to secure the lid in place when opened.
4. Hinge: A mechanism facilitating the rotational movement of the lid for easy access to the sprinkler mechanism.
6. Lid: A protective covering for the cylindrical structure, shielding the internal components from environmental factors.
7. Mini Cylinder of the Lid: The main body of the lid, seamlessly integrating with the protective cover system.

FIG. I: Side View with opened Lid (Perspective shadowing)
1. Cylinder: The outer perimeter of the cylindrical structure, delineating its boundary and providing structural support.
2. Upper Part of Cylinder: An extended border surrounding the cylindrical structure, enhancing protective coverage and stability.
3. Lid Stopper: A component designed to secure the lid in place when opened.
4. Hinge: A mechanism facilitating the rotational movement of the lid for easy access to the sprinkler mechanism.
5. Hole in the Hinge with Pin: A perforation in the hinge allowing the insertion of a pin, enabling smooth pivoting of the lid.
6. Lid: A protective covering for the cylindrical structure, shielding the internal components from environmental factors.
7. Mini Cylinder of the Lid: The main body of the lid, seamlessly integrating with the protective cover system.

These labeled components provide a comprehensive understanding of the protective cover system for garden sprinklers, highlighting its structural features and functional aspects in various perspectives.

1. A protective cover system for garden sprinklers comprises a PVC enclosure with a lid mechanism.

2. The system of claim 1, wherein the lid mechanism is synchronized with the vertical movement of the garden sprinkler.

3. A method for protecting garden sprinklers from environmental damage involves the automated deployment and retraction of a protective lid during sprinkler operation and rest.

4. The method of claim 3, further comprises a system to detect the sprinkler's status and trigger the lid accordingly.

5. An automated protective cover system for garden sprinklers, as described in the specification, to safeguard against dirt, debris, and other sources that may cause damage to the sprinkler.
